(19) United States
(12) Patent Application Publication
(10) Pub. No.: US 2002/0131570 A1
(43) Pub. Date: Sep. 19, 2002

(54) Method and apparatus for sending an audio and/or text announcement to a called telephone device

(76) Inventors: Katherine G. August, Matawan, NJ (US); Thomas W. Baker, Orefield, PA (US); Joseph M. Cannon, Harleysville, PA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/805,917

(22) Filed: Mar. 15, 2001

(51) Int. Cl. H04M 1/56

(52) U.S. Cl. 379/142.01

(57) ABSTRACT

A communications system is provided in which a short message service (SMS) message is sent from a calling telephone device to a called telephone device which contains caller identification information and an associated annunciation message. The called telephone stores the annunciation message in association with the identification information. The annunciation information is used whenever an incoming telephone call is received from the calling telephone device.

### FIELD OF THE INVENTION

The present invention relates to telephone communications, and more particularly to the field of identification of a calling party at a called communications device.

### BACKGROUND OF THE INVENTION

Oftentimes people placing telephone calls wish to announce themselves to a called party, and a called party often wishes to know who is calling. Caller-ID is one very popular feature which is provided in association with both wired and wireless telephones to enable a called party to determine who is calling. With the current proliferation of communication devices, the frequency of calls is ever increasing, and it becomes even more important for a called party to identify the origination of a call. Unfortunately, current Caller-ID features are somewhat limited to displaying the number of the calling party which is often not recognized by the called party, and requires a Caller-ID display associated with the called telephone. An easier way of finding out who is calling while signaling that a call is being received is needed.

### SUMMARY OF THE INVENTION

The present invention provides a telephone device which is capable of storing information messages in association with an identification of a calling telephone which may place a call to the telephone device. The stored information may include a unique display message and/or a unique ring indications. When a call is received at the telephone device, the telephone device can check to determine the identification of the calling party and can then determine if it has any stored information associated with the calling party and, if so, announce the calling party either with a more meaningful text message and/or with a unique ring indicator associated with a particular calling party.

The invention is particularly useful with a telephone device which is capable of receiving messages from a short messaging service (SMS), for example, a GSM telephone device which supports SMS messaging. A calling party may send text and/or ring information to the telephone device of the called party using the short message service for storage in association with the calling party's identification. Later, when the calling party makes a telephone call to the called party, the stored information is retrieved and used to annunciate the presence of a call from the calling party. The information stored at the called telephone device which is associated with the calling party may include text messages (for example, a name or business card message), or audible ring signals uniquely identifying the calling party, or both. In addition, the calling party may also be announced by converting a stored message associated with the calling party at the called telephone device from text to speech, thereby audibly announcing a received call from the calling party.

These and other advantages and features of the invention will be more readily understood from the following detailed description of the invention which is provided in connection with the accompanying drawings.

### BRIEF DESCRIPTION OF THE DRAWINGS

FIG. 1 illustrates a cellular system which also includes an associated short messaging service;

FIG. 2 is a flow chart of the operations performed at a called telephone device in accordance with the invention;

FIG. 3 illustrates how the invention can be employed when the calling party uses a wired (PSTN) telephone device; and

FIG. 4 illustrates the major components of a wireless telephone device in accordance with one embodiment of the invention.

### DETAILED DESCRIPTION OF THE INVENTION

The invention provides a way to uniquely identify a calling party by way of information stored in a called telephone device which is accessed when the called telephone device receives a call from a calling party whose identification is stored in the called telephone device. For purposes of the invention, the identification of a calling party will be indicated by unique identification information of the calling party, such as telephone number. A called telephone device in accordance with the invention has a storage area therein in which telephone numbers of potential calling parties are stored along with unique messages, so that when an incoming telephone call is recognized at the called device, the called telephone device can announce the incoming call using the stored information.

A calling party causes the unique message to be sent along with identification information of the calling party, to the telephone device of the called party by way of a digital message such as a short message service (SMS) message. The unique message is stored at the called telephone device in association with the calling party identification information.

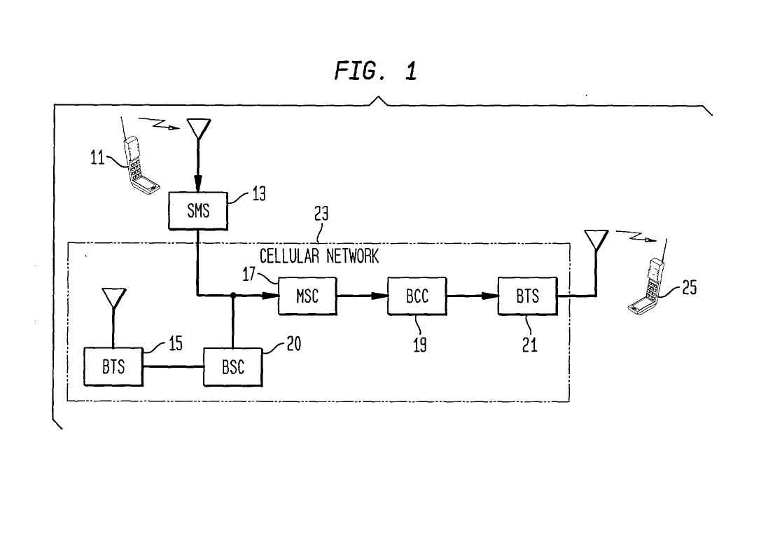

Referring first to FIG. 1, the invention is described in connection with a wireless communication system such as a GSM cellular telephone network which includes a short messaging service capability. However, it should be understood that this is only one exemplary embodiment of the invention, and that the invention can also be used with other wired or wireless telephone devices as well as over other conventional cellular and PSTN networks as long as the calling and called telephone devices are capable of sending and receiving SMS messages as well as conducting telephone communications.

FIG. 1 illustrates a GSM wireless calling telephone device 11 which, in addition to having conventional structures for making cellular telephone calls, also has a short messaging service (SMS) communication capability. Thus, calling device 11 can send SMS messages and place conventional telephone calls. Calling telephone 11 is capable of communicating with a GSM cellular network 23 through a short messaging service network which includes an SMS transceiver 13 for sending and receiving SMS messages. In addition, calling telephone 11 may also initiate conventional cellular telephone calls by communicating with a base transceiver station 15. Although FIG. 1 shows short messaging service, transceiver 13 and base transceiver station 15 as separate entities, they may in fact be combined as a single GSM base station transceiver which communicates with telephone device 11. The short messaging service transceiver 13 is capable of sending or receiving short message service messages, as is known in the art. Such messages, for example, are short text messages, paging messages, event notification messages, etc. The base transceiver station 15 is a well known component of a cellular telephone network and is the typical base station of such a network which is capable of servicing a plurality of wireless telephones within its assigned cell or cell sector.

In the illustrated exemplary embodiment, the short messaging service transceiver 13 and the base transceiver station 15 are coupled to a mobile service switching center (MSC) 17. Thus, an SMS message from calling device 11 is passed through the cellular network 23. In a non-GSM system, a separate SMS transmission network between calling telephone device 11 and a called telephone device 25 may be required for communicating the SMS message from device 11 to device 25. For purposes of further discussion, it will be assumed that the SMS message is used in a GSM system in which case it passes through cellular network 23 to the mobile service switching center 17. The mobile service switching center is in turn coupled to a station controller 19 which controls operations at several base stations, including a base station transceiver station 21 which is servicing telephone device 25.

A base station controller 20 also connects the base transceiver station 15 to the mobile service switching center 17 for conventional cellular telephone communications. The base transceiver station 21 in turn communicates with a wireless telephone device 25.

In accordance with the invention, the wireless telephone 11 uses the short messaging service capability to send an SMS message through SMS transceiver 13, MSC 17, BTS 21 (or through another SMS network) to telephone device 25. The SMS message includes an identification of the calling telephone device 11 and an associated annunciation message, both of which are received and stored at telephone device 25.

The SMS message may be composed on the key pad of the telephone device 11 and telephone device 11 further includes a control circuit such as a microprocessor to compose the message and pass it on to an SMS transceiver within telephone device 11 which transmits it to SMS transceiver 13.

Telephone device 25 receives SMS communications from a plurality of potential calling telephones 11 either through the cellular network 23 such as a GSM network or a separate SMS network and stores, in association with the identification information of each, the associated information message. Consequently, telephone device 25 contains a stored list of identification information for respective potential calling parties, as well as the associated annunciation message or messages for each. The annunciation message may be a text message and/or ring information associated with the calling party. The annunciation message may also be a text message which is connected to audio in the called telephone device by a text-to-speech converter.

FIG. 4 illustrates in block diagram form the simplified circuitry of a telephone device 25 which is designed to receive both the identification information and associated messages from potential calling parties 11 contained in an SMS communication. Telephone device 25 is a GSM telephone device which has both telephone and SMS capabilities. The telephone device includes a transmit receiver section 61 which is coupled to a control circuit 63, which in a preferred embodiment is a microprocessor. The microprocessor is in turn coupled to a telephone ringer device 65, a display device 67 and, optionally, a text-to-speech circuit 69, the output of which is sent to speaker 71.

It should be noted that the same core circuitry as illustrated in FIG. 4 may also be used by GSM telephone device 11 to compose and then transmit the SMS message to SMS transceiver 13 as well as place telephone calls. That is, control circuit 63 can receive keypad inputs to compose the SMS message which is then passed to transceiver 61 for transmission.

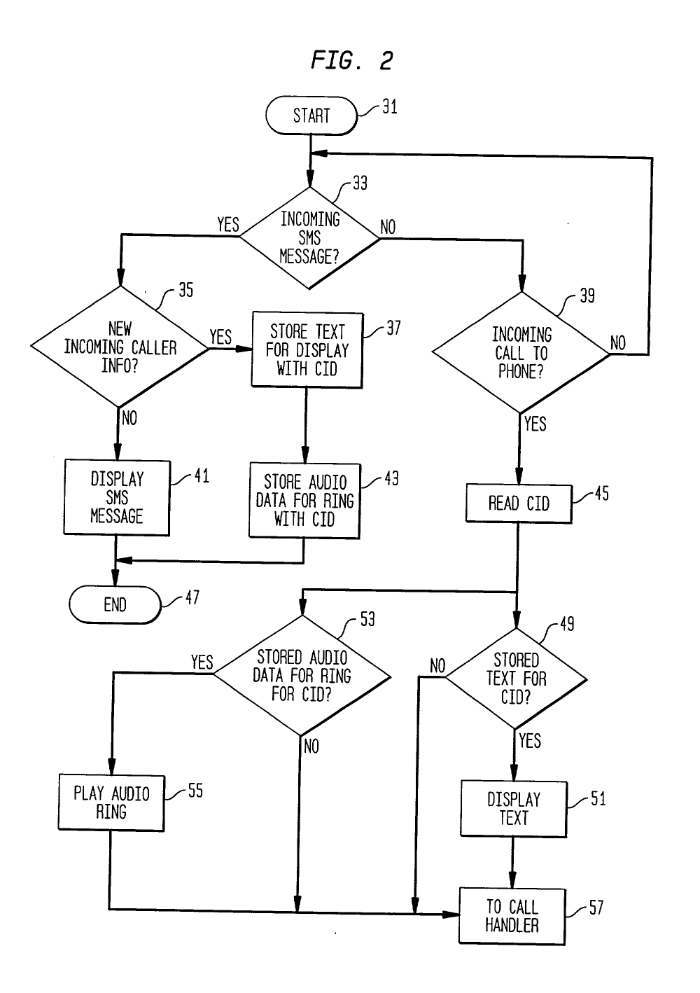

The operation of the telephone device 25 which stores the identifications of potential calling parties and associated annunciation messages, is illustrated in FIG. 2. The overall process illustrated in FIG. 2 is executed in the control circuit 63 which, as noted, is preferably a microprocessor.

The process begins at segment 31, and the first segment 33 determines whether telephone device 25 is receiving an incoming SMS message. If not, at processing 39 segment telephone device 25 determines whether it is receiving an incoming telephone call. If not, telephone device 25 proceeds back to processing segment 33 and awaits either an incoming SMS message or an incoming telephone call.

Assuming an incoming SMS message is detected at processing segment 33, telephone device 25 then determines whether or not the incoming SMS message contains caller identification information. If it does, telephone device 25 then stores any SMS message text for later display, together with the caller identification information. The caller identification information may take the form of conventional Caller-ID information, such as the calling party's telephone number.

In addition to storing text associated with the caller identification information, the telephone device 25 also stores any audio data for a ring which is also associated with the caller identification information and which may also be present in a received SMS message. After storing the text and audio data at process segments 37 and 43, respectively, telephone device 25 proceeds to end processing at step 47 and returns to the beginning of step 33 to determine if any new SMS messages or incoming calls are present.

If in processing segment 35 the telephone device 25 determines that there was no new incoming caller identification information, indicating that the SMS message is a conventional SMS message, the telephone device 25 then proceeds to display the SMS message in processing segment 41, after which it ends its processing and returns to step 33 to await a new SMS message or incoming telephone call.

If in processing segment 39 an incoming telephone call was detected, the telephone device 25 then reads the identification information, if present, associated with the incoming call at process segment 45. At this point, telephone device 25 then determines any text associated with the caller identification information and/or any stored ring data which is associated with the stored identification information. If stored text is found at processing segment 49, the text is displayed at processing segment 51, and the call is then turned over to the conventional call handler software 57 provided at the telephone device 25. Likewise, if there is stored audio data for a ring associated with the identification information, this is used in place of the conventional telephone ringing signal at processing segment 55. In lieu of audio ring data, the ring data may be vibrations of the telephone or ring information displayed on displace device 67. After this is done, telephone device 25 proceeds to process the call with the call handler software at processing segment 57.

As described above, the telephone device 25 is capable of storing via a short messaging service communications path, potential calling telephone device identifications and, in association therewith, annunciation messages for a calling party. Annunciation messages may be in the form of particular audio ring signals associated with a calling party, and/or a text message associated with a calling party. The stored text message may be converted to an audio message with the text-to-speech circuitry 69 illustrated in FIG. 4, in which case the stored text is presented as an audio signal to the called telephone device 25.

With the invention, a calling party is easily identified either by a particular text display message which can, for example, be a business card, a name of a person, or an audio text message or other information which a potential calling party wishes to send the telephone device 25 in the SMS message, as well as unique ring signals which can be associated with a calling party.

Thus far, the invention has been described in the context of using wireless telephone devices 11 and 25, working through a GSM cellular type network. As noted earlier, it is also possible to implement the invention in other wireless environments in which case a separate SMS wireless communication path and telephone path are provided between the telephone devices 11 and 25.

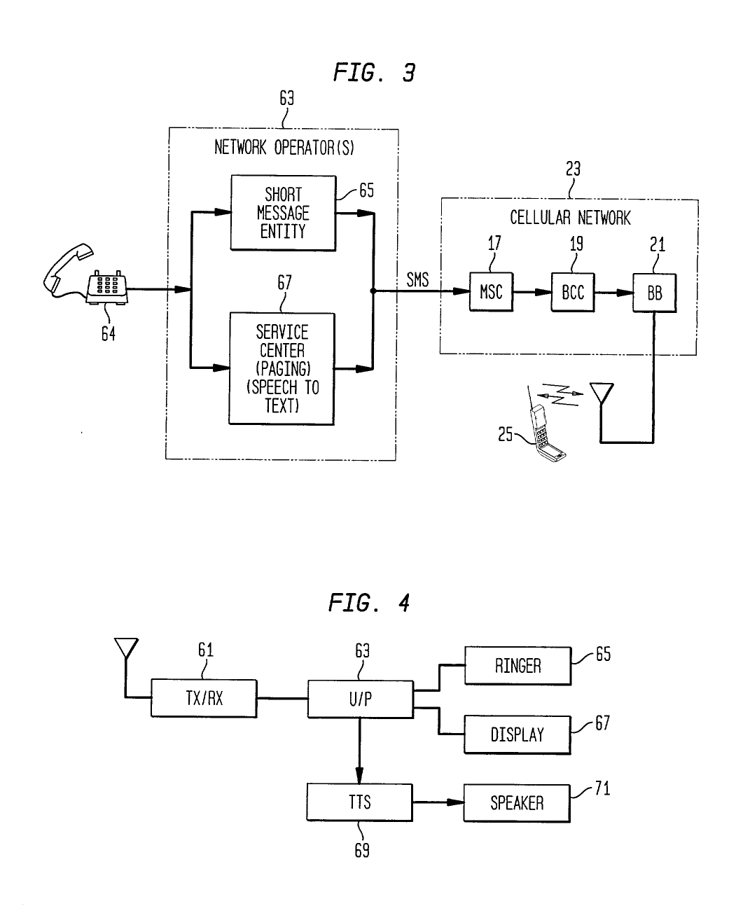

FIG. 3 illustrates a partial wired and partial wireless communication path between a potential calling party 61 and telephone device 25. Since telephone device 25 is still in this embodiment illustrated as a GSM wireless device connected to the same GSM cellular network 23 as described above with reference to FIG. 1.

On the calling party side, however, a landline connection is illustrated from a telephone device 61 through a network operator system 63, which includes both a short message service entity 65 which provides short message service capability, and a service center paging, speech-to-text, etc., facility 67, which can provide messages over a paging system.

Thus the telephone device 61 can send via short message entity 65 or by service center entity 67 a message which includes identification information of telephone device 61 as well as annunciation information such as text message and/or ring indicators and which is processed through the cellular network 23 to the telephone device 25 for storage thereat of the text message in association with a unique identification of the telephone device 61. Consequently, later when telephone device 61 makes a regular telephone connection to the telephone device 25 via a landline, i.e. PSTN connection, as well as through the cellular network 23, the telephone device 25 is able to identify and annunciate the calling party by a unique ring and/or text message which was stored by the calling party in telephone device 25 using the short message and/or paging service.

While the invention has been described with reference to specific embodiments thereof, many modifications and substitutions can be made without departing from the spirit and scope of the invention. Accordingly, the invention is not to be considered as limited by the foregoing description, but is only limited by the scope of the appended claims.

What is claimed as new and desired to be protected by Letters Patent of the United States is:

1. A method of operating a telephone device, said method comprising:
receiving an incoming data message from a message sending device;
determining if said received data message contains identification information for a telephone calling device; and
when said received data message does not contain said identification information, processing said data message at said telephone device to provide an indication of the content of said message.

2. A method as in claim 1, wherein when said data message contains said identification information, said method further comprises storing said identification information at said telephone device together with information received in said data message which is associated with said identification information.

3. A method as in claim 2 wherein said information associated with said identification information includes a text message which is displayable on said telephone device whenever said telephone device receives an incoming telephone call from said telephone calling device.

4. A method as in claim 2 wherein said information associated with said identification information includes information which causes said telephone device to uniquely announce an incoming telephone call from said telephone calling device.

5. A method as in claim 4 wherein said annunciation information includes a ring indication uniquely associated with said telephone calling device.

6. A method as in claim 5 wherein said ring indication is an audible signal.

7. A method as in claim 5 wherein said ring indication is a vibrational signal.

8. A method as in claim 5 wherein said ring indication is a visual signal.

9. A method as in claim 1 wherein said incoming data message is a short messaging service message.

10. A method as in claim 1 wherein said telephone device is a wireless telephone device.

11. A method as in claim 1 wherein said identification information is Caller-ID information.

12. A method as in claim 2 wherein said information associated with said identification information includes a text message, said method further comprising converting said text message to an audio message at said telephone device.

13. A method of operating a telephone device, said method comprising:
receiving an incoming telephone call;
determining if said incoming telephone call contains identification information associated with the calling party;
determining the identification information and determining whether said telephone device contains any stored information which is associated with said identification information;
if said stored information is found, using said stored information to announce an incoming call from said calling party.

14. A method as in claim 13 wherein said information associated with said identification information includes a text message which is displayable on said telephone device whenever said telephone device receives an incoming telephone call from said telephone calling device.

15. A method as in claim 13 wherein said information associated with said identification information includes information which causes said telephone device to uniquely announce an incoming telephone call.

16. A method as in claim 15 wherein said annunciation information includes a ring indication uniquely associated with said telephone calling device.

17. A method as in claim 16 wherein said ring indication is an audible signal.

18. A method as in claim 16 wherein said ring indication is a vibrational signal.

19. A method as in claim 16 wherein said ring indication is a visual signal.

20. A method as in claim 13 wherein said telephone device is a wireless telephone device.

21. A method as in claim 13 wherein said identification information is Caller-ID information.

22. A method of operating a telephone device capable of receiving data messages, said method comprising:
receiving an incoming data message from a message sending device;
determining if said incoming data message contains new incoming calling party identification information and, if it does, storing said identification information together with information received in said data message which is associated with said identification information.

23. A method as in claim 22 wherein said information associated with said identification information includes a text message which is displayable on said telephone device whenever said telephone device receives an incoming telephone call from said telephone calling device.

24. A method as in claim 22 wherein said information associated with said identification information includes information which causes said telephone device to uniquely announce an incoming telephone call from said telephone calling device.

25. A method as in claim 24 wherein said annunciation information includes a ring indication uniquely associated with said telephone calling device.

26. A method as in claim 22 wherein said incoming data message is a short messaging service message.

27. A method as in claim 22 wherein said telephone device is a wireless telephone device.

28. A method as in claim 22 wherein said identification information is Caller-ID information.

29. A method of operating a calling telephone device, comprising:
sending a message from said calling telephone to a receiving telephone device, said message containing an identification of the calling device and information to be used by said receiving telephone device to announce receipt of a telephone call from said calling telephone device.

30. A method as in claim 29 wherein said message is an SMS message.

31. A method as in claim 29 wherein said information includes ring information to be used whenever said calling telephone device places a call to said receiving telephone device.

32. A method as in claim 29 wherein said information includes a text message to be displayed by a receiving telephone device whenever said calling telephone device places a telephone call to said receiving telephone device.

33. A telephone device comprising:
a circuit for receiving a data message transmission;
a control circuit for examining a received data message transmission and determining if said data message transmission contains identification information of a device which can communicate with said telephone device and, if so, for storing said identification information together with information in said data message transmission which is associated with said identification information.

34. A telephone device as in claim 33 wherein if said received data message transmission does not contain said identification information, said control circuit causes said telephone device to provide an indication of the message content of said data message transmission.

35. A telephone device as in claim 34 further comprising a display device, said control circuit causing said display device to display said message content.

36. A telephone device as in claim 34 further comprising a text-to-speech circuit, said control circuit causing said text-to-speech circuit to provide n audio indication of said message content.

37. A telephone device as in claim 33 wherein said identification information is caller identification information.

38. A telephone device as in claim 33 wherein said data message transmission is an SMS message.

39. A telephone device as in claim 33 wherein said information associated with said identification information includes a text message which is displayable on said telephone device whenever said telephone device receives an incoming telephone call from said telephone calling device.

40. A telephone device as in claim 33 wherein said information associated with said identification information includes communication information which causes said telephone device to uniquely announce an incoming telephone call from said telephone calling device.

41. A telephone device as in claim 40 wherein said annunciation information includes a ring indication uniquely associated with said telephone calling device.

42. A telephone device as in claim 41 wherein said ring indication is an audible signal.

43. A telephone device as in claim 41 wherein said ring indication is a vibrational signal.

44. A telephone device as in claim 41 wherein said ring indication is a visual signal.

45. A telephone device as in claim 33 wherein said incoming data message is an SMS message.

46. A telephone device comprising:
a circuit for receiving an incoming telephone call;
a control circuit for determining if a received telephone call contains identification information associated with a calling party and if said telephone device has information stored therein which is associated with said identification information, said control circuit using stored information associated with said identification information to announce an incoming call from said calling party.

47. A telephone device as in claim 46 wherein said information associated with said identification information includes a text message which is displayable on said telephone device whenever said telephone device receives an incoming telephone call from said telephone calling device.

48. A telephone device as in claim 46 wherein said information associated with said identification information includes information which causes said telephone device to uniquely announce an incoming telephone call from said telephone calling device.

49. A telephone device as in claim 48 wherein said annunciation information includes a ring indication uniquely associated with said telephone calling device.

50. A telephone device as in claim 49 wherein said ring indication is an audible signal.

51. A telephone device as in claim 49 wherein said ring indication is a vibrational signal.

52. A telephone device as in claim 49 wherein said ring indication is a visual signal.

53. A telephone device as in claim 46 wherein said incoming data message is an SMS message.

54. A telephone device as in claim 46 wherein said telephone device is a wireless telephone device.

55. A telephone device as in claim 46 wherein said identification information is Caller-ID information.

56. A telephone device as in claim 46 further comprising a text-to-speech circuit for converting said stored information into audible information.

57. A calling telephone device comprising:
a control circuit for composing a message to be sent to a receiving telephone device, said message including a portion which identifies said calling telephone device and a portion which contains information for annunciating said calling device whenever it places a telephone call to said receiving telephone device; and
a transmitting circuit for transmitting said message.

58. A calling telephone device as in claim 57 wherein said message is an SMS message.

59. A calling device as in claim 57 wherein said information includes ring information.

60. A calling device as in claim 57 wherein said information includes display information.

61. A calling device as in claim 57 wherein said information includes audible information.
